(19) United States
(12) Patent Application Publication
(10) Pub. No.: US 2018/0275496 A1
(43) Pub. Date: Sep. 27, 2018

(54) WAVELENGTH CONVERSION ELEMENT, LIGHT SOURCE DEVICE, AND PROJECTOR

(71) Applicant: SEIKO EPSON CORPORATION, Tokyo (JP)

(72) Inventor: Tetsuo SHIMIZU, Matsumoto-shi (JP)

(73) Assignee: SEIKO EPSON CORPORATION, Tokyo (JP)

(21) Appl. No.: 15/916,084

(22) Filed: Mar. 8, 2018

(30) Foreign Application Priority Data
Mar. 22, 2017 (JP) 2017-055716

(51) Int. Cl. G03B 21/20

(52) U.S. Cl. CPC G03B 21/204; G03B 21/005

(57) ABSTRACT

A wavelength conversion element includes a phosphor layer, a support member, and a thermal stress reduction member disposed between the phosphor layer and the support member.

### BACKGROUND

### 1. Technical Field

The present invention relates to a wavelength conversion element, a light source device, and a projector.

### 2. Related Art

In recent years, there exists a light source device having a solid-state light source such as a semiconductor laser, and a wavelength conversion element provided with a phosphor layer combined with each other. In such a light source device, the fluorescence conversion efficiency decreases as the temperature of the phosphor layer rises. For example, in the light source device disclosed in JP-A-2011-129354 (Document 1), the cooling efficiency of the phosphor is improved by bonding the phosphor layer to a heat radiation substrate with a metal bonding material. Further, in the light source device disclosed in JP-A-2016-177979 (Document 2), the cooling efficiency of the phosphor is improved by bonding the phosphor layer to a heat radiation substrate with solder having a void function equal to or lower than 75%.

However, in the light source device described in Document 1 mentioned above, since the linear expansion coefficient is different between the phosphor layer and the heat radiation substrate, there is a possibility that the phosphor layer is broken to be separated due to the thermal stress when the phosphor layer generates heat. Further, in the light source device described in Document 2 mentioned above, since the solder as a bonding material includes voids, the mechanical strength is low, and there is a possibility that the phosphor layer is separated due to the thermal stress when the phosphor layer generates heat.

### SUMMARY

An advantage of some aspects of the invention is to provide a wavelength conversion element hard to be damaged by the heat. Another advantage of some aspects of the invention is to provide a light source device equipped with the wavelength conversion element described above. Still another advantage of some aspects of the invention is to provide a projector equipped with light source device described above.

According to a first aspect of the invention, a wavelength conversion element is provided. The wavelength conversion element includes a phosphor layer, a support member, and a thermal stress reduction member disposed between the phosphor layer and the support member.

According to the wavelength conversion element related to the first aspect of the invention, the damage due to the difference in linear expansion coefficient between the phosphor layer and the support member is hard to occur.

In the first aspect of the invention described above, it is preferable that the support member is formed of metal, and the thermal stress reduction member includes a metal material having a thermal stress absorption function for reducing thermal stress due to a difference in linear expansion coefficient between the phosphor layer and the support member.

According to this configuration, since it is possible to efficiently transfer the heat of the phosphor layer to the support member via the thermal stress reduction member, the rise in temperature of the phosphor layer can be reduced.

In the first aspect of the invention described above, it is preferable that the metal material is a soft metal material.

According to this configuration, the damage is harder to occur.

In the first aspect of the invention described above, it is preferable that the Mohs hardness of the thermal stress reduction member is lower than the Mohs hardness of the support member.

According to this configuration, the damage is harder to occur.

In the first aspect of the invention described above, it is preferable that the metal material is a porous material.

According to this configuration, the damage is harder to occur.

In the first aspect of the invention described above, it is preferable that the metal material is formed of a material selected from a group consisting of indium, silver chloride, lead, tin, magnesium, silver, zinc, sulfur, copper, and gold.

According to this configuration, the damage is harder to occur.

In the first aspect of the invention described above, it is preferable that the support member is formed of metal, and the thermal stress reduction member includes a resin material having a thermal stress absorption function for reducing thermal stress due to a difference in linear expansion coefficient between the phosphor layer and the support member.

Since the thermal stress reduction member including the resin material is excellent in flexibility, the damage is harder to occur.

According to a second aspect of the invention, a light source device is provided. The light source device includes the wavelength conversion element according to the first aspect of the invention, and a light emitting element adapted to emit excitation light for exciting the phosphor layer.

Since in the light source device according to the second aspect of the invention, the damage due to the heat is hard to occur, it is possible for the light source device according to the second aspect of the invention to stably emit the light.

According to a third aspect of the invention, a projector is provided. The projector includes the light source device according the second aspect of the invention described above, a light modulation device adapted to modulate illumination light from the light source device in accordance with image information to form image light, and a projection optical system adapted to project the image light.

The projector according to the third aspect of the invention is equipped with the illumination device in which the damage due to the heat is hard to occur, and is therefore high in reliability.

### BRIEF DESCRIPTION OF THE DRAWINGS

The invention will be described with reference to the accompanying drawings, wherein like numbers reference like elements.

FIG. 1 is a diagram showing a schematic configuration of a projector according to a first embodiment of the invention.

FIG. 2 is a diagram showing a schematic configuration of an illumination device.

FIG. 3 is a diagram for explaining the state of a fluorescence emitting element when emitting fluorescence.

FIG. 4 is a cross-sectional view showing a configuration of a fluorescence emitting element according to a second embodiment of the invention.

FIG. 5 is a cross-sectional view showing a configuration of a fluorescence emitting element according to a third embodiment of the invention.

### DESCRIPTION OF EXEMPLARY EMBODIMENTS

Some embodiments of the invention will hereinafter be described in detail with reference to the drawings.

It should be noted that the drawings used in the following description show characteristic parts in an enlarged manner in some cases for the sake of convenience in order to make the features easy to understand, and the dimensional ratios between the constituents and so on are not necessarily the same as actual ones.

### First Embodiment

Firstly, an example of a projector according to the present embodiment will be described.

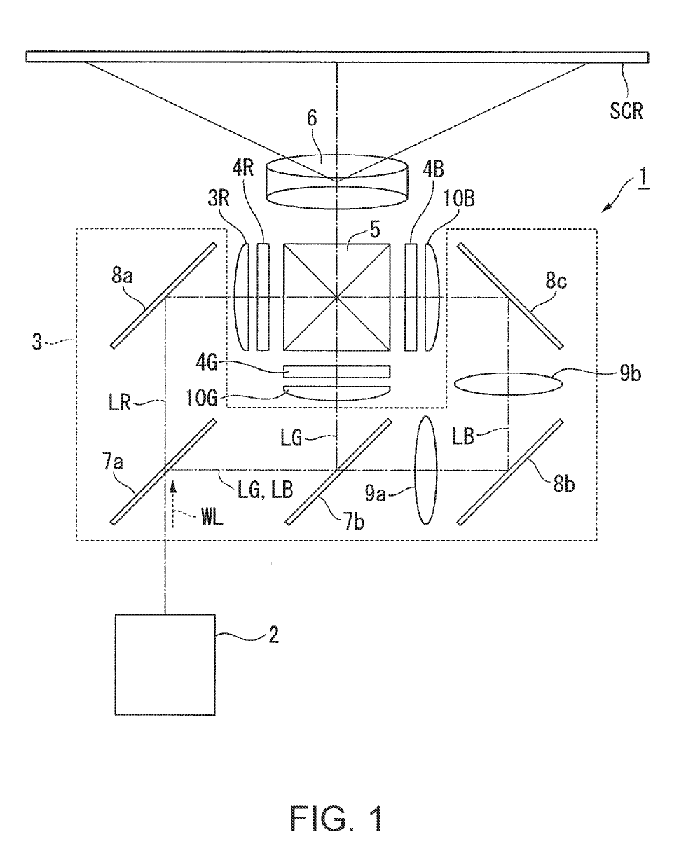

FIG. 1 is a diagram showing a schematic configuration of the projector according to the present embodiment.

As shown in FIG. 1, the projector 1 according to the present embodiment is a projection-type image display device for displaying a color picture on a screen SCR. The projector 1 is provided with an illumination device 2, a color separation optical system 3, a light modulation device 4R, a light modulation device 4G, a light modulation device 4B, a combining optical system 5, and a projection optical system 6.

The color separation optical system 3 separates white light WL into red light LR, green light LG, and blue light LB. The color separation optical system 3 is provided with a first dichroic mirror 7a and a second dichroic mirror 7b, a first total reflection mirror 8a, a second total reflection mirror 8b, and a third total reflection mirror 8c, and a first relay lens 9a and a second relay lens 9b.

The first dichroic mirror 7a separates the illumination light WL from the illumination device 2 into the red light LR and the other light (the green light LG and the blue light LB). The first dichroic mirror 7a transmits the red light LR thus separated from, and at the same time reflects the rest of the light. The second dichroic mirror 7b reflects the green light LG, and at the same time transmits the blue light LB.

The first total reflection mirror 8a reflects the red light LR toward the light modulation device 4R. The second total reflection mirror 8b and the third total reflection mirror 8c guide the blue light LB to the light modulation device 4B. The green light LG is reflected from the second dichroic mirror 7b toward the light modulation device 4G.

The first relay lens 9a and the second relay lens 9b are disposed in the posterior stage of the second dichroic mirror 7b in the light path of the blue light LB.

The light modulation device 4R modulates the red light LR in accordance with image information to form red image light. The light modulation device 4G modulates the green light LG in accordance with the image information to form green image light. The light modulation device 4B modulates the blue light LB in accordance with the image information to form blue image light.

As the light modulation device 4R, the light modulation device 4G, and the light modulation device 4B, there are used, for example, transmissive liquid crystal panels. Further, in the incident side and the exit side of each of the liquid crystal panels, there are respectively disposed polarization plates (not shown).

Further, on the incident side of the light modulation device 4R, the light modulation device 4G, and the light modulation device 4B, there are disposed a field lens 10R, a field lens 10G, and a field lens 10B, respectively.

The image light from each of the light modulation devices 4R, 4G, and 4B enters the combining optical system 5. The combining optical system 5 combines the image light, and then emits the image light thus combined toward the projection optical system 6. As the combining optical system 5, there is used, for example, a cross dichroic prism.

The projection optical system 6 is formed of a projection lens group, and projects the image light combined by the combining optical system 5 toward the screen SCR in an enlarged manner. Thus, the color picture enlarged is displayed on the screen SCR.

### Illumination Device

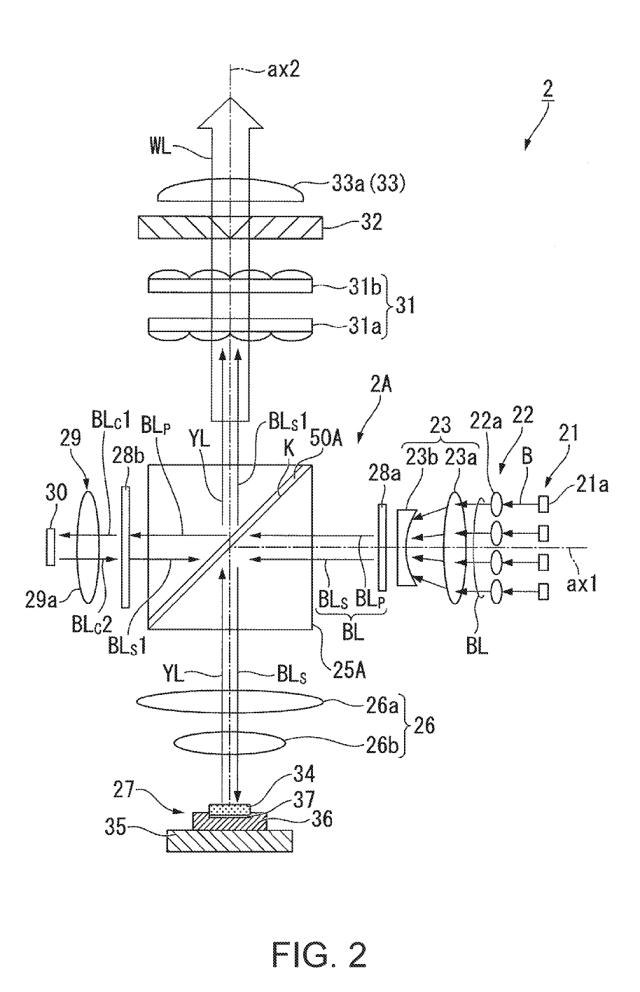

Next, the illumination device 2 according to an embodiment of the invention will be described. FIG. 2 is a diagram showing a schematic configuration of the illumination device 2. As shown in FIG. 2, the illumination device 2 is provided with a light source device 2A, an integrator optical system 31, a polarization conversion element 32, and an overlapping lens 33a. In the present embodiment, the integrator optical system. 31 and the overlapping lens 33a form an overlapping optical system 33.

The light source device 2A is provided with an array light source 21, a collimator optical system 22, an afocal optical system 23, a first wave plate 28a, an optical element 25A including a polarization separation element 50A, a first light collection optical system 26, a fluorescence emitting element 27, a second wave plate 28b, a second light collection optical system 29, and a diffusely reflecting element 30.

In the light source device 2A, the array light source 21, the collimating optical system 22, the afocal optical system 23, the first wave plate 28a, the optical element 25A, the second wave plate 28b, the second light collection optical system 29, and the diffusely reflecting element 30 are disposed in series on an optical axis ax1 sequentially side by side. The fluorescence emitting element 27, the first light collection optical system 26, the optical element 25A, the integrator optical system 31, the polarization conversion element 32, and the overlapping lens 33a are disposed in series on an optical axis ax2. The optical axis ax1 and the optical axis ax2 are located in the same plane, and are perpendicular to each other. The optical axis corresponds to the illumination light axis of the illumination device 2.

The array light source 21 is provided with a plurality of semiconductor lasers 21a. The plurality of semiconductor lasers 21a is disposed in an array in the same plane perpendicular to the optical axis ax1. The semiconductor lasers 21a each emit, for example, a blue ray B (e.g., a laser beam with a peak wavelength of 460 nm). The array light source 21 emits a pencil BL formed of a plurality of rays B. In the present embodiment, the semiconductor lasers 21a correspond to a “light emitting element” in the appended claims.

The pencil BL emitted from the array light source 21 enters the collimator optical system 22. The collimator optical system 22 converts the light beams B emitted from the array light source 21 into parallel light beams. The collimator optical system 22 is formed of, for example, a plurality of collimator lenses 22a arranged in an array. The collimator lenses 22a are disposed so as to correspond respectively to the semiconductor lasers 21a.

The pencil BL having been transmitted through the collimator optical system 22 enters the afocal optical system 23. The afocal optical system 23 adjusts the light beam diameter of the pencil BL. The afocal optical system 23 is formed of, for example, a convex lens 23a and a concave lens 23b.

The pencil BL having been transmitted through the afocal optical system 23 enters the first wave plate 28a. The first wave plate 28a is, for example, a half-wave plate having an optical axis arranged to be able to rotate around the optical axis ax1. The pencil BL is linearly polarized light. By appropriately setting the rotational angle of the first wave plate 28a, it is possible to set the pencil BL having been transmitted through the first wave plate 28a to the light beam including an S-polarization component and a P-polarization component with respect to the polarization separation element 50A at a predetermined ratio.

The pencil BL, which includes the S-polarization component and the P-polarization component bypassing through the first wave plate 28a, enters the optical element 25A. The optical element 25A is formed of, for example, a dichroic prism having wavelength selectivity. The dichroic prism has a tilted surface K having an angle of 45° with the optical axis ax1. The tilted surface K also has an angle of 45° with the optical axis ax2.

The tilted surface K is provided with the polarization separation element 50A having wavelength selectivity. The polarization separation element 50A has a polarization separation function of splitting the pencil BL into a pencil BLs as the S-polarization component with respect to the polarization separation element 50A and a pencil BLp as the P-polarization component. Specifically, the polarization separation element 50A reflects the pencil BLs as the S-polarization component, and transmits the pencil BLp as the P-polarization component.

Further, the polarization separation element 50A has a color separation function of transmitting fluorescence YL different in wavelength band from the pencil BL irrespective of the polarization state of the fluorescence YL.

The pencil BLs as the S-polarized light having been emitted from the polarization separation element 50A enters the first light collection optical system 26. The first light collection optical system 26 converges the pencil BLs toward a phosphor layer 34 as excitation light. In the present embodiment, the pencil BLs corresponds to “excitation light” in the appended claims.

In the present embodiment, the first light collection optical system 26 is formed of, for example, a first lens 26a and a second lens 26b. The pencil BLs having been emitted from the first light collection optical system 26 enters the fluorescence emitting element 27 in a converged state.

The fluorescence emitting element 27 has the phosphor layer 34, a support member 35 for supporting the phosphor layer 34, a thermal stress reduction member 36 disposed between the phosphor layer 34 and the support member 35, and a reflecting section 37 disposed between the thermal stress reduction member 36 and the phosphor layer 34. In the present embodiment, the fluorescence emitting element 27 corresponds to a “wavelength conversion element” in the appended claims.

In the present embodiment, the phosphor layer 34 is a sintered body obtained by sintering a plurality of YAG phosphor particles. The phosphor layer 34 is excited by the pencil BLs, and emits the fluorescence (yellow light) YL having a peak wavelength in a wavelength band of, for example, 500 through 700 nm. The phosphor layer 34 is superior in hear resistance to the phosphor layer including an organic binder.

The surface of the phosphor layer 34 on the opposite side to the side where the pencil BLs enters is fixed to the support member 35 via the thermal stress reduction member 36.

A part of the fluorescence YL generated by the phosphor layer 34 is reflected by the reflecting section 37, and is then emitted to the outside of the phosphor layer 34. As the reflecting section 37, what is high in reflectance is preferable, and a dielectric multilayer film is used in the present embodiment. In such a manner, the fluorescence YL is emitted from the phosphor layer 34 toward the first light collection optical system 26.

As the support member 35, what is excellent in thermal conductivity is preferable, and a plate-like member made of metal is used in the present embodiment. In the present embodiment, a copper plate is used as the support member 35. It should be noted that it is also possible to use aluminum as the material of the support member 35.

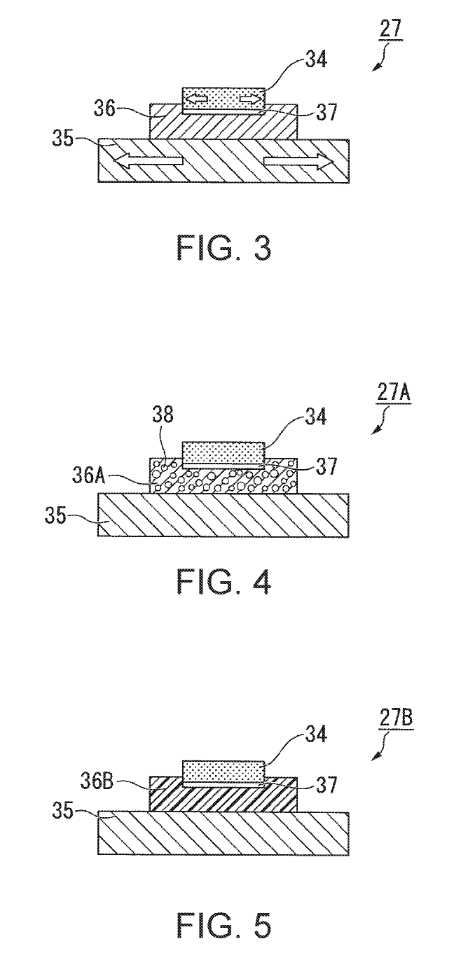

Incidentally, when the phosphor layer 34 is irradiated with the excitation light (the pencil BLs), the temperature of the phosphor layer 34 rises. FIG. 3 is a diagram for explaining the state of the fluorescence emitting element 27 in the case in which the temperature of the phosphor layer 34 is rising.

Since the phosphor layer 34 and the support member 35 are different in linear expansion coefficient from each other, when the phosphor layer 34 is irradiated with the excitation light, the thermal stress is generated. Specifically, the linear expansion coefficient of the support member 35 is higher than the linear expansion coefficient of the phosphor layer 34. Therefore, as shown in FIG. 3, an amount of the expansion (an amount of extension) of the support member 35 becomes larger than an amount of the expansion (an amount of extension) of the phosphor layer 34. On this occasion, there is a possibility that the phosphor layer 34 is broken or separated from the support member 35 due to the thermal stress generated in the phosphor layer 34.

In contrast, the fluorescence emitting element 27 of the present embodiment is provided with the thermal stress reduction member 36 disposed between the support member 35 and the phosphor layer 34. The thermal stress reduction member 36 is a bonding member for bonding the phosphor layer 34 and the support member 35 to each other. The thermal stress reduction member 36 includes a metal material having a thermal stress reduction function for reducing the thermal stress generated in the phosphor layer 34 when irradiating the phosphor layer 34 with the excitation light. It should be noted that the phosphor layer 34 and the thermal stress reduction member 36 are bonded to each other via a metalization layer (not shown) formed on a surface of the phosphor layer 34. The metalization layer is not necessarily required, and can also be omitted in the case in which the sufficient bonding strength can be obtained.

The Mohs hardness of the thermal stress reduction member 36 is lower than the Mohs hardness of the support member 35. In the present embodiment, the thermal stress reduction member 36 is formed of a soft metal material low in Mohs hardness. The soft metal material is selected from a group of, for example, indium, silver chloride, lead, tin, magnesium, silver, zinc, sulfur, copper, and gold. Table 1 below shows the Mohs hardness of the soft metal materials.

TABLE 1

| SOFT METAL MATERIAL | MOHS HARDNESS |
|---|---|
| INDIUM | 1.2 |
| SILVER CHLORIDE | 1.3 |
| LEAD | 1.5 |
| TIN | 1.5-1.8 |
| MAGNESIUM | 2 |
| SILVER | 2 |
| ZINC | 2 |
| SULFUR | 1.5-2.5 |
| COPPER | 2.5-3 |
| GOLD | 2.5-3 |

It should be noted that in the case of using copper or gold as the thermal stress reduction member 36, it is preferable to use aluminum as the material of the support member 35. According to this configuration, it is possible to make the thermal stress reduction member 36 lower in Mohs hardness than the support member 35 described above.

The thermal stress reduction member 36 formed of such a soft metal material has high thermal conductivity as a feature of the metal, and is at the same time superior in flexibility. Therefore, it is possible for the thermal stress reduction member 36 to efficiently transfer the heat of the phosphor layer 34 to the support member 35, to reduce the stress strain generated in the phosphor layer 34. Therefore, the damage of the fluorescence emitting element 27 due to the thermal stress is hard to occur.

Going back to FIG. 2, the fluorescence YL emitted from the phosphor layer 34 is non-polarized light. The fluorescence YL passes through the first light collection optical system 26, and then enters the polarization separation element 50A. Then the fluorescence YL proceeds from the polarization separation element 50A toward the integrator optical system 31.

Meanwhile, the pencil BLp as the P-polarized light having been emitted from the polarization separation element 50A is converted by the second wave plate 28b into blue light BLc1 as clockwise circularly polarized light, and then enters the second light collection optical system 29. The second wave plate 28b is formed of a quarter-wave plate.

The second light collection optical system 29 is formed of, for example, a lens 29a, and makes the blue light BLc1 enter the diffusely reflecting element 30 in a converged state.

The diffusely reflecting element 30 diffusely reflects the blue light BLc1, which has been emitted from the second collection optical system 29, toward the polarization separation element 50A. As the diffusely reflecting element 30, it is preferable to use an element of causing the Lambertian reflection of the blue light BLc1, and at the same time not to disturb the polarization state.

Hereinafter, the light diffusely reflected by the diffusely reflecting element 30 is referred to as blue light BLc2. According to the present embodiment, by diffusely reflecting the blue light BLc1, there can be obtained the blue light BLc2 having a roughly homogenous illuminance distribution. The blue light BLc1 as the clockwise circularly polarized light is reflected as the blue light BLc2 as counterclockwise circularly polarized light.

The blue light BLc2 is converted by the second light collection optical system 29 into parallel light, and is then transmitted though the second wave plate 28b to be converted into the blue light BLs1 as the S-polarized light. The blue light BLs1 is reflected by the polarization separation element 50A toward the integrator optical system 31.

The blue light BLs1 and the fluorescence YL are emitted from the polarization separation element 50A toward the respective directions the same as each other, and thus, there is formed the white illumination light WL having the blue light BLs1 and the fluorescence (the yellow light) YL mixed with each other.

The illumination light WL is emitted toward the integrator optical system 31. The integrator optical system 31 is formed of, for example, a lens array 31a, and a lens array 31b. The lens arrays 31a, 31b are each formed of what has a plurality of small lenses arranged in an array.

The illumination light WL having been transmitted through the integrator optical system 31 enters the polarization conversion element 32. The polarization conversion element 32 is formed of a polarization separation film and a wave plate. The polarization conversion element converts the illumination light WL including the fluorescence YL as the non-polarized light into linearly polarized light.

The illumination light WL having been transmitted through the polarization conversion element 32 enters the overlapping lens 33a. The overlapping lens 33a homogenizes the distribution of the illuminance due to the illumination light WL in the illumination target area in cooperation with the integrator optical system 31. The illumination device 2 emits the illumination light WL in such a manner as described above.

In the illumination device 2 according to the present embodiment, the damage of the fluorescence emitting element 27, specifically, the damage or the separation of the phosphor layer 34, due to the difference in linear expansion coefficient between the phosphor layer 34 and the support member 35 is hard to occur. Therefore, it is possible for the illumination device 2 to stably emit the illumination light WL. Therefore, the projector 1 according to the present embodiment equipped with the illumination device 2 is high in reliability.

### Second Embodiment

Next, an illumination device according to a second embodiment will be described. The present embodiment and the first embodiment are difference from each other in the configuration of the fluorescence emitting element, and are the same in the other configurations. Therefore, the configurations and the members common to the first embodiment and the present embodiment will be denoted by the same reference symbols, and the detailed description thereof will be omitted, or simplified.

FIG. 4 is a cross-sectional view showing a configuration of a fluorescence emitting element 27A according to the present embodiment.

As shown in FIG. 4, the fluorescence emitting element 27A of the present embodiment is provided with a thermal stress reduction member 36A disposed between the support member 35 and the phosphor layer 34. The thermal stress reduction member 36A according to the present embodiment is a bonding member for bonding the phosphor layer 34 and the support member 35 to each other. The thermal stress reduction member 36A includes a metal material having a thermal stress reduction function for reducing the thermal stress generated in the phosphor layer 34 when irradiating the phosphor layer 34 with the excitation light.

In the present embodiment, the metal material constituting the thermal stress reduction member 36A is a porous material. Therefore, the thermal stress reduction member 36A has a number of holes 38. The metal material (hereinafter referred to as porous metal in some cases) formed of such a porous material is selected from a group of, for example, indium, silver chloride, lead, tin, magnesium, silver, zinc, sulfur, copper, and gold.

Since the thermal stress reduction member 36A formed of such porous metal is excellent in flexibility, the damage of the fluorescence emitting element 27, specifically, the damage or the separation of the phosphor layer 34, due to the difference in linear expansion coefficient between the phosphor layer 34 and the support member 35 is hard to occur.

### Third Embodiment

Next, an illumination device according to a third embodiment will be described. The present embodiment and the first embodiment are difference from each other in the configuration of the fluorescence emitting element, and are the same in the other configurations. Therefore, the configurations and the members common to the first embodiment and the present embodiment will be denoted by the same reference symbols, and the detailed description thereof will be omitted, or simplified.

FIG. 5 is a cross-sectional view showing a configuration of a fluorescence emitting element 27B according to the present embodiment.

As shown in FIG. 5, the fluorescence emitting element 27B of the present embodiment is provided with a thermal stress reduction member 36B disposed between the support member 35 and the phosphor layer 34. The thermal stress reduction member 36B is a bonding member for bonding the phosphor layer 34 and the support member 35 to each other. The thermal stress reduction member 36B includes a resin material having a thermal stress reduction function for reducing the thermal stress generated in the phosphor layer 34 when irradiating the phosphor layer 34 with the excitation light. It should be noted that it is also possible for the thermal stress reduction member 36B to include metal particles made of, for example, Ag providing the thermal stress reduction member 36B is formed mainly of the resin material. Since the thermal conductivity is improved by including the metal particles as described above, it is possible to efficiently transfer the heat of the phosphor layer 34 to the support member 35.

The resin material constituting the thermal stress reduction member 36B of the present embodiment is formed of an organic adhesive material such as silicone or epoxy. Since the thermal stress reduction member 36B formed of such a resin material is excellent in flexibility, the damage of the fluorescence emitting element 27, specifically, the damage or the separation of the phosphor layer 34, due to the difference in linear expansion coefficient between the phosphor layer 34 and the support member 35 is hard to occur.

It should be noted that the invention is not limited to the contents of the embodiments described above, but can arbitrarily be modified within the scope or the spirit of the invention.

For example, although in the embodiments described above, those of a stationary type are cited as examples of the fluorescence emitting elements 27, 27A and 27B, it is also possible to adopt those of a rotary type having the support member 35 capable of rotating as the fluorescence emitting elements 27A, 27B and 27C.

Further, although in the embodiment described above, there is illustrated the projector 1 provided with the three light modulation devices 4R, 4G, and 4B, the invention can also be applied to a projector for displaying a color picture with a single light modulation device. Further, a digital mirror device can also be used as the light modulation device.

Further, although in the embodiment described above, there is described the example of installing the illumination device according to the invention in the projector, the invention is not limited to this example. The illumination device according to the invention can also be applied to lighting equipment, a headlight of a vehicle, and so on.

The entire disclosure of Japanese Patent Application No. 2017-055716, filed on Mar. 22, 2017 is expressly incorporated by reference herein.

What is claimed is:

1. A wavelength conversion element comprising:
a phosphor layer;
a support member; and
a thermal stress reduction member disposed between the phosphor layer and the support member.

2. The wavelength conversion element according to claim 1, wherein
the support member is formed of metal, and
the thermal stress reduction member includes a metal material having a thermal stress absorption function for reducing thermal stress due to a difference in linear expansion coefficient between the phosphor layer and the support member.

3. The wavelength conversion element according to claim 2, wherein
the metal material is a soft metal material.

4. The wavelength conversion element according to claim 2, wherein
a Mohs hardness of the thermal stress reduction member is lower than a Mohs hardness of the support member.

5. The wavelength conversion element according to claim 2, wherein
the metal material is a porous material.

6. The wavelength conversion element according to claim 2, wherein
the metal material is formed of a material selected from a group consisting of indium, silver chloride, lead, tin, magnesium, silver, zinc, sulfur, copper, and gold.

7. The wavelength conversion element according to claim 1, wherein
the support member is formed of metal, and
the thermal stress reduction member includes a resin material having a thermal stress absorption function for reducing thermal stress due to a difference in linear expansion coefficient between the phosphor layer and the support member.

8. A light source device comprising:
the wavelength conversion element according to claim 1; and
a light emitting element adapted to emit excitation light for exciting the phosphor layer.

9. A light source device comprising:
the wavelength conversion element according to claim 2; and
a light emitting element adapted to emit excitation light for exciting the phosphor layer.

10. A light source device comprising:
the wavelength conversion element according to claim 3; and
a light emitting element adapted to emit excitation light for exciting the phosphor layer.

11. A light source device comprising:
the wavelength conversion element according to claim 4; and
a light emitting element adapted to emit excitation light for exciting the phosphor layer.

12. A light source device comprising:
the wavelength conversion element according to claim 5; and
a light emitting element adapted to emit excitation light for exciting the phosphor layer.

13. A light source device comprising:
the wavelength conversion element according to claim 6; and
a light emitting element adapted to emit excitation light for exciting the phosphor layer.

14. A light source device comprising:
the wavelength conversion element according to claim 7; and
a light emitting element adapted to emit excitation light for exciting the phosphor layer.

15. A projector comprising:
the light source device according to claim 8;
a light modulation device adapted to modulate light from the light source device in accordance with image information to form image light; and
a projection optical system adapted to project the image light.

16. A projector comprising:
the light source device according to claim 9;
a light modulation device adapted to modulate light from the light source device in accordance with image information to form image light; and
a projection optical system adapted to project the image light.

17. A projector comprising:
the light source device according to claim 10;
a light modulation device adapted to modulate light from the light source device in accordance with image information to form image light; and
a projection optical system adapted to project the image light.

18. A projector comprising:
the light source device according to claim 11;
a light modulation device adapted to modulate light from the light source device in accordance with image information to form image light; and
a projection optical system adapted to project the image light.

19. A projector comprising:
the light source device according to claim 12;
a light modulation device adapted to modulate light from the light source device in accordance with image information to form image light; and
a projection optical system adapted to project the image light.

20. A projector comprising:
the light source device according to claim 13;
a light modulation device adapted to modulate light from the light source device in accordance with image information to form image light; and
a projection optical system adapted to project the image light.
